(19) United States
(12) Patent Application Publication
(10) Pub. No.: US 2011/0276631 A1
(43) Pub. Date: Nov. 10, 2011

(54) SYSTEMS AND METHODS FOR ACCESSING INFORMATION FROM MULTIPLE NETWORKS, SOCIAL GRAPHS, AND CONTENT SITES

(76) Inventor: Steven J. Schmitt, Pittsburgh, PA (US)

(21) Appl. No.: 13/100,841

(22) Filed: May 4, 2011

Related U.S. Application Data
(60) Provisional application No. 61/331,371, filed on May 4, 2010.

(51) Int. Cl. G06F 15/16

(52) U.S. Cl. 709/205

(57) ABSTRACT

Methods and systems for providing access to information and connections associated with or derived from social graphs, including social networks, professional networks, and content sharing and publishing sights are described herein. Embodiments provide for registering members in a system network, obtaining social graph information from the members, aggregating the member social graphs into a social graph network, obtaining and analyzing profile information from the social graphs within the social graph network, providing access to the social graph network.

### CROSS REFERENCE TO RELATED APPLICATION

This application claims the benefit of U.S. Provisional Patent Application Ser. No. 61/331,371, entitled “Systems and Methods for Multi-Level Professional Referral Social Networking,” filed on May 4, 2010, the contents of which are incorporated by reference as if fully set forth herein.

### FIELD OF THE INVENTION

The subject matter presented herein generally relates to Internet-based talent management in relation to professional recruitment and candidate referrals, including providing access to multiple networks, including, but not limited to, social graphs, social networks, professional networks, and content centered web sites.

### BACKGROUND

Employers currently have a limited number of resources for locating candidates for open positions. Typical methods include print advertising and partnering with staffing and recruitment agencies. More recently, a first wave of web sites established the feasibility of utilizing the Internet to post employment positions and search for potential candidates, for example, through online job boards. Among these web sites are resume posting and job search sites, such as MONSTER.COM®. MONSTER.COM is a registered trademark of TMP Worldwide Inc. in the United States and other countries. Although the Internet is now considered a vital job placement resource, online job boards and recruitment sites have long been losing their effectiveness, especially in high demand industries such as information technology and healthcare, and have not adapted to fully realize the potential of recent technological advances.

A second wave of web sites established the popularity of social networking and real-time information sites. Among these social networking sites are social utilities, such as Facebook®, video sharing web sites such as YouTube®, and professional social networks such as LinkedIn® provide a network for professionals, companies, and organizations. Facebook is a registered trademark of Facebook, Inc. LinkedIn is a registered trademark of LinkedIn Ltd. In addition, real-time information sites, such as Twitter® and Digg® provide users with access to dynamic sources of information and news. As such, current technology now provides for many different sources of information and methods for connecting people through the Internet.

### BRIEF SUMMARY

In summary, one aspect of the invention provides a system comprising: one or more processors; a system memory operatively coupled to the one or more processors; and one or more aggregation modules communicatively coupled to the system memory, wherein the one or more aggregation modules are adapted to: register one or more system members, each of the one or more system members belonging to one or more social graphs; aggregate a social graph network of the one or more social graphs; access profile information of members of the social graph network; analyze the social graph network and the profile information for connections between the one or more social graphs; and provide a access to the one or more social graphs through the social graph network.

In summary, another aspect of the invention provides a method comprising: registering one or more system members, each of the one or more system members belonging to one or more social graphs; aggregating a social graph network of the one or more social graphs; accessing profile information of members of the social graph network; analyzing the social graph network and the profile information for connections between the one or more social graphs; and providing access to the one or more social graphs through the social graph network.

In summary, a further aspect of the invention provides a computer program product comprising: a computer readable storage medium having computer readable program code embodied therewith, the computer readable program code comprising: computer readable program code configured to register one or more system members arranged in one or more system networks, each of the one or more members belonging to one or more external networks; computer readable program code configured to register one or more system members, each of the one or more system members belonging to one or more social graphs; computer readable program code configured to aggregate a social graph network of the one or more social graphs; computer readable program code configured to access profile information of members of the social graph network; computer readable program code configured to analyze the social graph network and the profile information for connections between the one or more social graphs; and computer readable program code configured to provide access to the one or more social graphs through the social graph network.

### BRIEF DESCRIPTION OF THE SEVERAL VIEWS OF THE DRAWINGS

FIG. 1 provides example talent management platform interface according to an embodiment.

FIG. 2 provides an example member network according to an embodiment.

FIG. 3 provides an example of information available to the talent management platform according to an embodiment.

FIG. 4 provides an example of social networking and information web site affiliations of a talent management platform member.

FIG. 5 provides an example of Network as a Service (NaaS) according to an embodiment

FIG. 6 provides an example of recommendation engine operation with a private network according to an embodiment.

FIG. 7 provides an example of recommendation engine operation with a private network according to an embodiment.

FIG. 8 provides an example of recommendation operation with a staffing firm entity according to an embodiment.

FIG. 9 illustrates example staffing agencies' sales and recruiting functions.

FIG. 10 provides an example job referral exchange according to an embodiment.

FIG. 11 provides an example computer system.

### DETAILED DESCRIPTION

It will be readily understood that components of the embodiments, as generally described and illustrated in the figures herein, may be arranged and designed in a wide variety of different configurations in addition to the described example embodiments. Thus, the following more detailed description of embodiments, as represented in the figures, is not intended to limit the scope of the invention, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that various embodiments can be practiced without one or more of the specific details, or with other methods, components, materials, et cetera. In other instances, well-known structures, materials, or operations are not shown or described in detail to avoid obfuscation. Throughout this description, example embodiments are described in connection with a computer, such as a desktop, laptop, or notebook computer; however, those skilled in the art will recognize that certain embodiments are equally applicable to other types of electronic devices.

A successful organization today must recruit and retain the best talent to remain competitive. However, there is little alternative but to rely on inefficient conventional methods, such as print advertising and online job boards, or to partner with firms in the professional staffing industry that depend on inefficient tools, technologies, and processes. These firms include staffing, recruiting, headhunting, and consulting firms. Although these professional staffing firms are able to provide some assistance to employers, research suggests they have ultimately created an environment that lacks certain necessary characteristics, such as efficiency, trust, reliability, and accountability.

While endeavoring to recruit and retain talent, human resource (HR) departments are also being faced with several other critical issues, including a massive shortage of skilled professionals, a hyper-competitive business climate, a complicated global workforce, and labor becoming highly specialized. These issues are exacerbated in industries where demand significantly exceeds supply for qualified professionals, such as information technology, healthcare, and energy. Accordingly, employers and HR managers, who are often under enormous pressure to attract talent, are seeking innovative, trustworthy, and effective ways to connect with qualified candidates and to maintain current operations in line with their organization's efforts to fuel new growth.

A highly sought after source of talent is passive job seekers—potential candidates not actively pursuing job opportunities, but may consider a new position if presented with the right situation. These individuals are in demand because they are considered to represent the most talented and productive segment of the workforce. However, these individuals are difficult to locate and present with new opportunities because they are not actively looking for a job. Current job referral methods are not adequately configured to locate passive candidates because these methods do not have the ability to locate such candidates and communicate with them.

Embodiments provide a talent management platform configured to utilize connections and information available on the Internet. According to embodiments, members may register with the platform and provide or are required to register using one or more social networking credentials. For example, a new user may register using their LinkedIn® information. Embodiments are configured to access the networks of users, such as social networks, professional networks, alumni networks, and talent management platform networks in order to generate a platform network. In addition, embodiments provide that the platform network may be enhanced with additional layers of information, including, but not limited to, public records, government records, credit reports, and any information available through an Internet search that is associated with a particular network member or connection. Furthermore, embodiments may provide one or more combinations of networks wherein indirect connections between networks are established and made accessible.

As such, embodiments provide for a recommendation engine configured to recommend candidates for positions based on certain candidate factors. Illustrative and non-restrictive examples of candidate factors according to embodiments include whether the candidate's background matches the job requirements, how long the candidate has stayed at his current position, and whether the candidate has moved to a higher position each time that he has changed jobs. Accordingly, embodiments are able to recognize the distinctive characteristics of high value candidates for a particular position based on a dynamic set of factors.

In addition, embodiments provide incentives for members and associates of the professional talent management platform to actively participate in the recruitment and referral systems. As a non-limiting example, one embodiment provides that the incentives may consist of certain financial rewards allocated to platform members for directly or indirectly referring a candidate to an open position posted through the platform if the candidate ultimately is hired for the open position. Furthermore, embodiments are configured to generate a system of metrics for referrals made within the talent management platform. According to embodiments, each platform member has a credibility score that represents a measure of the quality of his referrals made within the platform. As a non-limiting example, the quality of the referrals made may be measured according to certain referral characteristics, including, but not limited to, how the referred candidate fits the job requirements or whether the referred candidate actually is interested in the position.

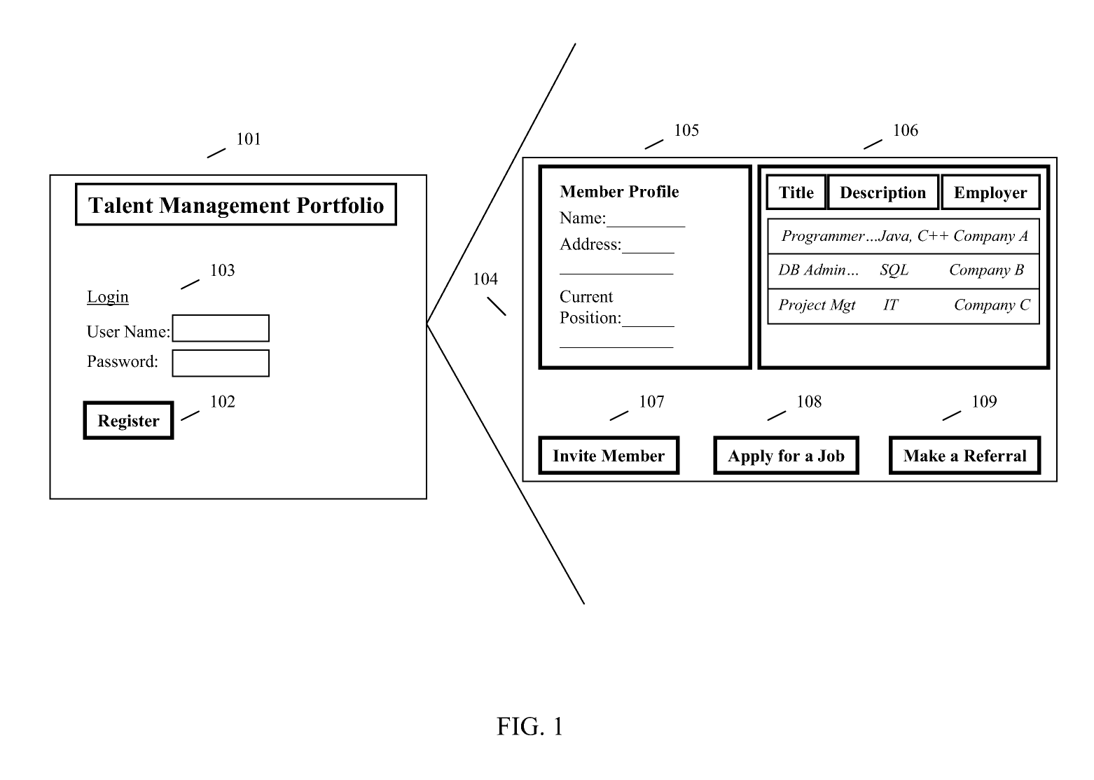

Referring to FIG. 1, therein is depicted an example talent management platform interface according to an embodiment. In the embodiment depicted in FIG. 1, the talent management platform is implemented as an Internet-based service with an interface 101 accessible through a web browser. According to embodiments, individuals register 102 as a new member at the platform web site. As an example member, consider an information technology professional, such as a software engineer, a network engineer, a project manager, a help desk professional, a database analyst, an ERP specialist, a web developer, a graphics designer, a technical writer, or an HR manager. In addition, embodiments provide that the member may take on different roles as part of his or her membership. Illustrative and non-restrictive examples of member roles include seeking full time employment, referring colleagues for open positions (jobs), and acting as a hiring manager or a consultant for one or more companies.

Registration may include choosing a member name and password, filling out a member profile (which can include for example both professional and personal information fields) and saving the membership information. In at least one embodiment, becoming a member and maintaining a membership will not require a fee. In another embodiment, a member may register using credentials from a social networking service, including, but not limited to, LinkedIn® or Facebook®.

After registering as a platform member, embodiments provide that a user may login 103 to the platform and access certain functions and services 104. For example, the functions and services may be available through a member profile or dashboard interface. As non-limiting examples, functions and services 104 may include creating and editing a member profile 105, viewing posted jobs 106, inviting members to join the platform 107, applying for a job 108, and referring a candidate for a job 109.

After a member has registered, certain embodiments provide that the talent management platform may utilize various methods to verify the member. According to embodiments, verification may be rigorous and may include one or more of the following: credit check(s), drug screening(s), verification of resume information (for example, education and employment information), and requiring direct invitation from an existing member.

Certain embodiments are configured to track a large amount of information regarding members. Such information may include, but is not limited to, social networking site characteristics; information resulting from background checks, credit checks, and/or drug screenings; customer ratings; basic demographics; resume information; and member invitation, platform promotional, and job listing procurement information. Such information may be gathered and organized by certain embodiments to form a repository of information regarding a particular member or members. In addition, embodiments may be configured to require such information of the members and make it accessible, for example, in an effort to create an exclusive set of members, as reflected by the information gathered and made available regarding the members.

Embodiments provide for talent management platform function interfaces that may be accessed from within the talent management platform interface. For example, a community-based user interface modality may be available according to embodiments, which integrates social networking sites, communications modalities (email, instant messaging, and the like), a jobs posting service, as well as various other Web 2.0 capabilities. The credibility score interface may include, but is not limited to, a member rating system, a system providing periodic to continuous feedback for members, and a validity checking system that may conduct and display results relating to various checks, such as credit checks and the like. In addition, embodiments provide for one or more interfaces that may include a reserving capability, a recruiting capability, or a retaining capability for members conducting recruiting services. Certain embodiments may further provide a growth interface according to an embodiment that includes, for example, an incentive plan and tracking thereof, a dashboard for hosting widgets, and accounting capabilities.

Embodiments are configured to provide members with opportunities including but not limited to contract assignments, full time jobs, projects, and freelance opportunities. Certain embodiments are configured to reward members for certain services, such as referring another member successfully or building a network from which a qualifying referral is received. According to embodiments, rewards may take various forms, including, but not limited to, increased member ranking, financial or other forms of remuneration, charitable donations, advanced access to job postings, enhanced referral abilities, or some combination thereof. In addition, embodiments are configured to make automated attribution of rewards to members. For example, a member may link a payment account to, or establish an in-house account with, the platform system and receive regular (for example, monthly) distributions of rewards (for example, payments/account deposits) for his or her qualifying events. Furthermore, embodiments provide that members may designate one or more charitable endeavors to receive earned rewards.

Each member may be associated with a network according to embodiments. For example, embodiments provide that a user may invite members to join his network, while other embodiments may leverage social networking web sites to assist members in building a network, as by leveraging a member's existing contacts from other social networking sites as a starting point for identifying candidates for referral.

According to embodiments, if a user registers using social networking credentials, the talent management platform may obtain available social network information, including the profile information of the user's social network contacts. As such, certain embodiments are configured to interface the talent management platform with various other social networking web sites and other web sites to facilitate information retrieval and importation from these other web sites, such as contacts lists, member characteristics, organization characteristics, and the like. The member's network may, for example, comprise a referral network, such that a member may receive a reward when any one in his or her network receives a reward.

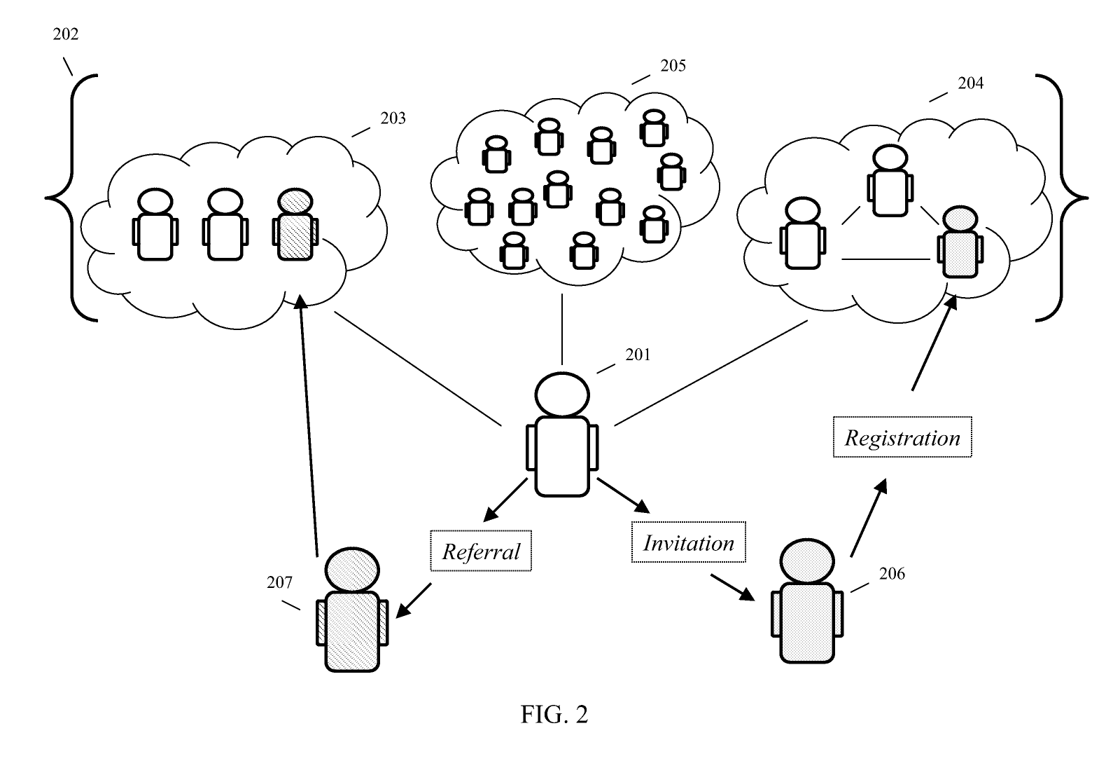

Referring to FIG. 2, therein is depicted an example member network for according to an embodiment. A talent management platform member, Member 1, 201 may have a network 202 consisting of connections, including, but not limited to, referral connections 203, member connections 204, and outside network connections 205. In addition, embodiments provide for other types of networks (not shown), such as a public platform network and one or more private networks each associated with a private entity.

Embodiments provide that referral connections 203 may be comprised of platform referrals related to Member 1 201, such as referrals made directly by Member 1 201 or referrals made by members of Member 1's 201 network 202 (i.e., member connections 204). According to embodiments, member connections 204 may consist of platform members in Member 1's 201 network 202. For example, if Member 1 201 invites Member 2 206 to join the talent management platform and Member 2 206 registers with the platform, Member 2 206 is in Member 1's 201 network 202. Embodiments provide for the automated handling of invitations, for example, by a member executing an invitation function from the talent management platform interface and providing certain information regarding the invited individual, such as the individual's email address.

In another example, Member 1 201 refers Candidate 1 207 for a position and, in response, Candidate 1 207 becomes linked to Member 1 201 as a referral made by Member 1 201 within the platform. Furthermore, embodiments provide that a member's network may consist of outside network connections 205, such as social networks the member has joined. For example, if Member 1 201 is a member of LinkedIn®, Member 1's 201 LinkedIn® accessible network of connections may be accessed as outside network connections 205 in Member 1's 201 network 202.

Following registration and verification, embodiments provide that members may have access to job postings, which may include a frequently updated listing of job postings, such as daily updated job postings. A member, in response to reviewing the job postings, may search his or her personal network for individuals that may match the job postings. Certain embodiments help to automate this search by automatically suggesting certain “friends” of the member that may qualify. Such automated suggesting may include, for example, comparing one or more metrics associated with the job posting to one or more metrics associated with the “friends” profiles in the member's personal network on the system (which again may be imported from other web sites). Thereafter, the member may make a referral. If the position is filled in response to the member's referral, the member may qualify for an incentive reward.

Certain embodiments allow for better, faster and cheaper location of talent compared to prior talent management approaches, for example by leveraging member's use of social networking web sites. This is in part because according to certain embodiments, more people will be looking for the desired talent, for example, by employing contacts from other social networking sites. Members trying to identify qualified talent will be highly motivated to do so, because of both positive incentives (for example, remuneration) and negative incentives (decreased member ranking or credibility score), which may be accrued over time. Moreover, certain embodiments provide for more passive candidates to be identified, for example by leveraging interaction with other social networking web sites, with enforced credibility for members recommending these passive candidates. Certain embodiments will reduce costs associated with talent management by virtue of having less turnover. For example, as a result of more qualified candidates being identified and recommended in the first place due to a long term incentive approach according to embodiments.

A system according to embodiments may include one or more modules such as a candidate module, a jobs module, a credibility score module, a reference/referral module, a rewards module and a communications module. The system may communicate via the communications module with one or more remote devices such as a member's client device (for example, a personal computer), one or more other web sites hosted by remote devices (for example, servers), such as social networking sites or other web sites (for example, customer sites or industry web sites).

According to embodiments, the candidate module is configured to store one or more lists of potential candidates, for example, members within a particular member's network of contacts or other contacts as identified from other web sites. Embodiments provide that the jobs module may be configured to store one or more jobs listings, such as listings submitted by potential employers looking for qualified professional talent. Embodiments provide that the referral/reference module may be configured to store one or more lists of contacts actually referred or referenced by a member for particular positions. According to embodiments, that credibility score module may be configured to store one or more credibility scores associated with a member's performance within the system, for example, over specific period of time or over the duration of a user's membership. Embodiments provide for a rewards module that may be configured to store accounting details, such as one or more rewards awarded to a member for past services, account details, and the like. Each of the modules may be configured according to embodiments to execute computer program code configured to carry out specific acts or functions associated with storing, updating, or modifying, relevant information associated with the functionality of the module. Moreover, systems consistent with embodiments may contain more or less modules than illustrated, such as two modules being consolidated and/or additional modules being added for executing functionality consistent with the systems and methods described herein. Moreover, the modules may be linked or combined in a variety of ways depending upon the particular use contemplated.

Embodiments may provide a member home page for display on a member's device, such as a personal computer. The member home page may contain a variety of functional units for executing commands requesting that a system as described herein perform functions consistent with those described herein. For example, a member homepage may include, but is not limited to, providing an email client, a messaging client, an accounting client, and an invite/recruiting client. The invite/recruiting client may provide functionality supporting member recruiting activities, such as providing an option to invite a new member to join the system, invite an existing member to become part of the particular member's personal network, and conducting recruiting services such as selecting another member and referring them as a candidate for a job opening. The accounting client may provide accounting services to the member, such as linking a member account to that of a financial institution such that the rewards issued to a member can be direct deposited into the member's account at a given financial institution.

In addition, the member home page may include a variety of tabs that, in response to selection, provide a convenient display of member activities. A contacts tab may be provided that displays a list of contacts of the member upon selection. The contacts may include both member network contacts within the system as well as member contacts as derived from one or more social networking sites to which the member belongs. A jobs listing tab, may include, for example, a listing of jobs deposited within the system by clients looking to fill open positions. A rewards tab may include a listing of current, past or pending rewards a member has or can obtain via activities within the system. A credibility score tab may include the member's credibility score regarding referral activities within the system. A referrals tab may include a listing of referrals the member has made. A references tab may include a list of references the member has made.

Furthermore, the member's home page may include links to other web sites, such as other social networking web sites the member belongs to or web sites dedicated to certain professional organizations. The member's home page may also include a search function such that the member may search within the system for other pages, such as pages of other members. The member's homepage according to certain embodiments may display one or more member rankings or credibility scores, viewable by other members.

A talent management platform according to embodiments is configured to obtain information from members. According to embodiments, such information includes, but is not limited to, networks, connections, or online communities associated with the member, resume information, talent management platform profile information, and other accessible personal information. The terms networks, connections, and online communities are collectively referred to as “member networks” within this specification, unless specified otherwise or discussed individually.

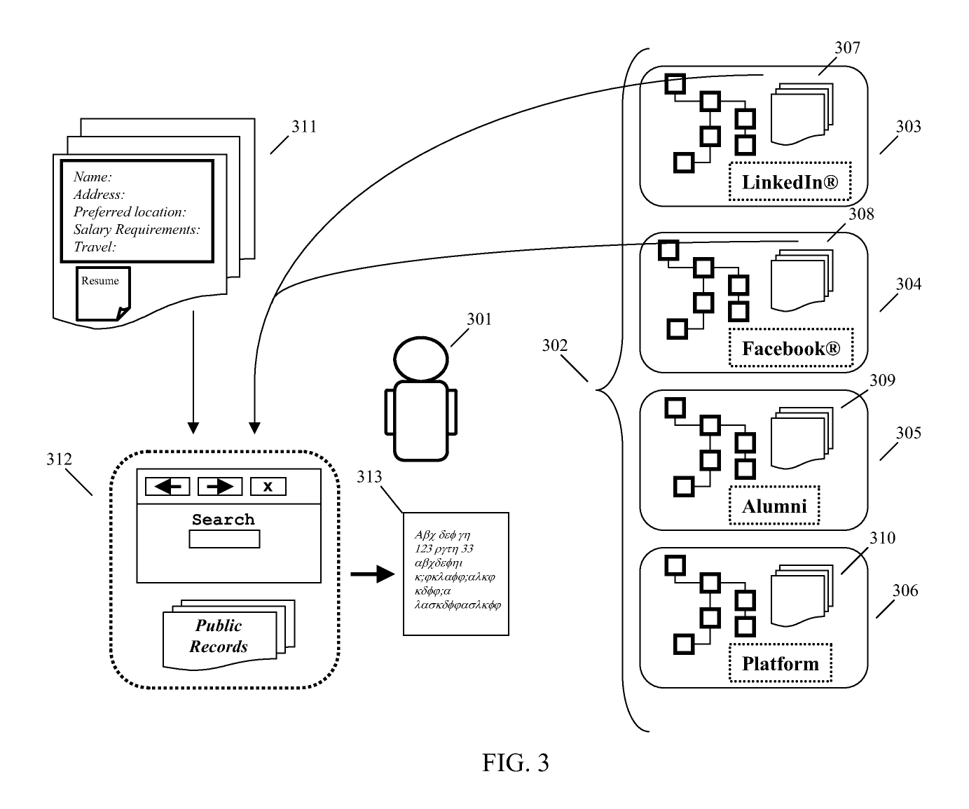

In FIG. 3, therein is provided an example of information available to the talent management platform according to an embodiment. A platform member 301 belongs to certain member networks 302, non-limiting examples provided in FIG. 3 include the social networks LinkedIn® 303 and Facebook® 304, an alumni network 305, and the platform network 306. The member networks 302 each have their own set of data 307-310, including network profile data, connections, and profile data of the connections.

Also shown in FIG. 3, information may be available through profile information supplied to the platform 311. Such information may include name and address information, a resume, and other personal information, such as preferred geographical region, desired position, willingness to travel, and salary requirement information. FIG. 3 also provides that enhanced information 313 may be obtained through information gathering and analysis 312, which may include generating inferences or assumptions from the available information, searching for publicly available information, such as public government records and information available online, and generating a profile for a specific member or candidate based on the located information based on available network data 307-311.

Embodiments are configured to utilize member networks including, but not limited to, the talent management platform network, social networks, alumni networks, and professional networks. For example, a talent management platform according to embodiments may require that members provide or join the platform using social network credentials. Embodiments are configured to obtain information from the member networks for use in determining candidate recommendations, including, but not limited to, member profile information, member connections, and profile information from the connections. According to existing technology, the API's of certain member networks, such as the social networks LinkedIn® and Facebook®, have been made publicly available. As such, embodiments may access the API's of social networks used by members and obtain their connections within said social networks. However, embodiments are not limited to accessing member networks through available API's, as any applicable method for obtaining information from member networks may be applied.

As previously described herein, current technology provides for many sources of information, people, and associated connections. However, although these sources may provide certain connections, such as shared links, there is a lot of overlap and a lack of a singular access interface. For example, users often have multiple accounts for multiple social networking and information web sites. It is common for an individual to have LinkedIn®, Facebook®, and Twitter® accounts. In addition, these accounts are individually linked to other members and other sources of information, unavailable through outside portals. An illustrative example demonstrating overlap provides that a first user may have a LinkedIn® account with a connection to a second user, while also having a Facebook® account wherein he is additionally connected to the second user. Furthermore, the first user may also have a Twitter® account with a link to a Twitter® account belonging to the second user, and so on.

Such conditions are repeated, as users are continually required to join different social networking and information web sites to use or fully operate within the site environment. For example, the content sharing site Digg® requires users to join to fully use its services. Although these sites may provide some account sharing, for example, using a Facebook® account to join Digg®, these web sites, networks, and connections remain largely disjointed and do not provide the ability for singular, shared access. As such, an individual attempting to ascertain the extent of another individual's networks, connections, and content posted on the Internet must proceed through a myriad of web sites, user names, and connection paths.

Embodiments provide for Network as a Service (NaaS), wherein social graphs of registered members arranged within a system network are made available through a single access point. In addition, embodiments further provide enhanced data and formatting of the network and connection information associated with users. According to embodiments, a certain enhanced category of platform members may access the networks, connections, and information associated with general platform members. As a non-limiting example, users, such as an employer, may access the NaaS network according to embodiments to browse or search for information, members, or connections, such as an employer searching for a candidate for an open position.

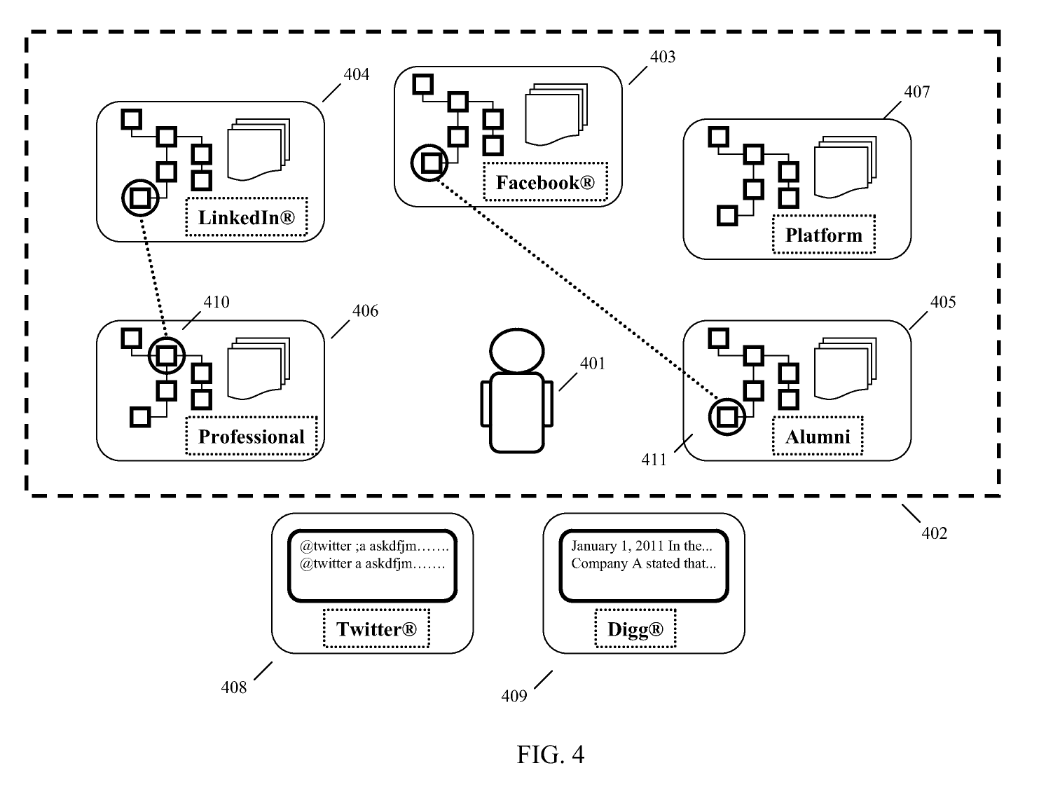

Referring to FIG. 4, therein is depicted an example of social networking and information web site affiliations of a talent management platform member. A member 401 belongs to multiple networks 402. The non-limiting example of networks 402 illustrated in FIG. 4 comprises the Facebook® 403 and LinkedIn® 404 networks, an alumni network 405, a local professional network 406, and the talent management platform network 407. Each of these networks 402 are themselves comprised of multiple connections. For example, Connection 1 410 is an individual connected to Member 1 in both the LinkedIn® 404 and local professional 406 networks, while Connection 2 411 is connected to Member 1 401 in both the Facebook® 403 and alumni networks 405.

Illustrated in FIG. 4, Member 1 401 is a member of the real-time information site Twitter® 408 and the content sharing site Digg® 409. These web site memberships may provide content postings which may be connected through shared links or links to individuals connected to Member 1 401 through one or more networks 402. As demonstrated in FIG. 4, the memberships, connections, and information associated with one individual may easily be very complicated and difficult to resolve into a useful set of information.

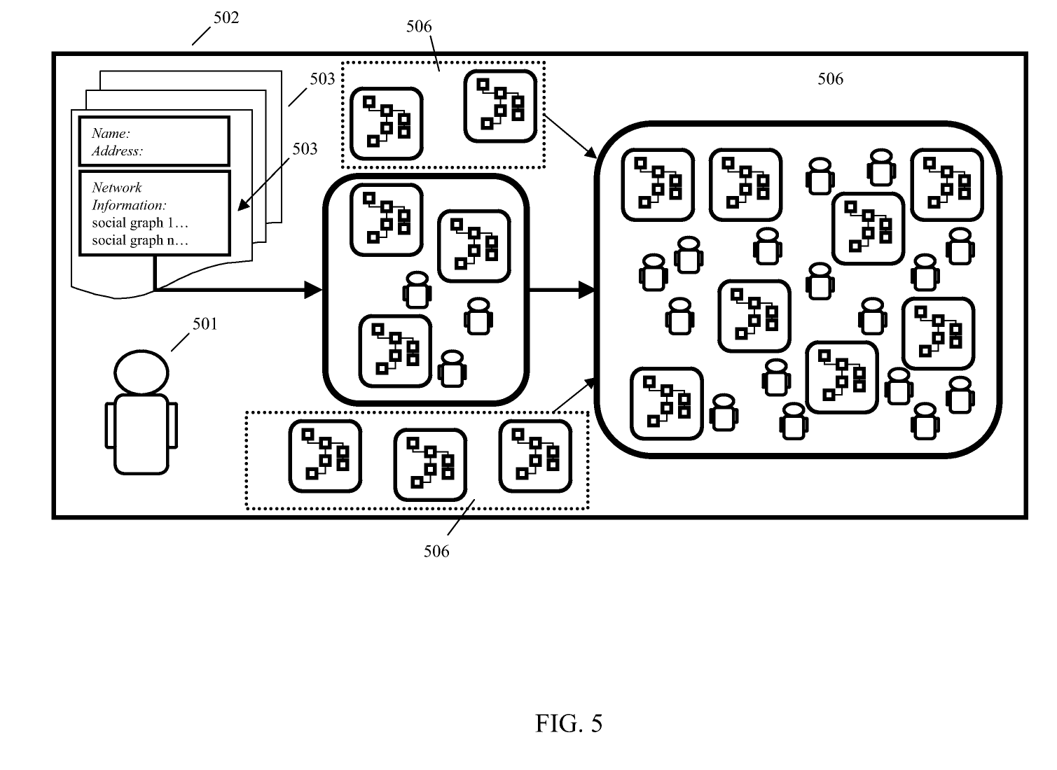

Referring now to FIG. 5, therein is depicted an example NaaS according to an embodiment. A member 501 registers with the talent management platform 502 and provides membership information 503 regarding his network and information sharing associations. In the example depicted in FIG. 5, the member 501 supplies membership information 503 pertaining to, inter alia, his LinkedIn®, Facebook®, alumni network, local professional network, Twitter®, and Digg® memberships. As a result, the platform 502 has access to network information 504 for the member 501, which the platform 502 may gather and organize to generate a NaaS network 505 for member 1 501. The NaaS network 505 for member 1 501, may be combined with NaaS networks of other members 506 to form a platform NaaS network 507 comprised of all of the membership, connection, public records, online content, and other related information associated with all of the platform members. A NaaS user may access the platform NaaS network 507 and utilize the associated information, for example, for locating potential job candidates or to check the background of a specified candidate under consideration.

According to embodiments, a platform NaaS network may contain membership information, including, but not limited to social graph membership, connection, and content information, or “member network information,” for social graph, real-time information, and content sharing web sites associated with the talent management platform members. In addition, embodiments provide that the platform NaaS network may contains enhanced information, including, but not limited to, overlaps between memberships and connections, public records, and other information accessible online. Within the platform NaaS network, embodiments provide that the member network information may be assembled and organized so that relationships and links between members, between members and their own network, and with member content may be readily accessible and useful for decision making by, for example, an employer seeking a job candidate.

Embodiments provide that certain talent management platform users (e.g., “enhanced users”) may access the NaaS network. The enhanced users may view and search the connections of members, or one member in particular. For example, an enhanced user may access the social graph and profile information for a particular members and their connections, including, but not limited to, social network connections, published online content, platform connections, and any other available information regarding a member and their connections. Non-limiting examples of such available information include, but are not limited to, public records, criminal history, blog postings, credit reports, and Internet search results. In addition, embodiments provide that information regarding connections between a member and other individuals, including, but not limited to, platform members, social networking members, or information publishing web sites may be accessible by the enhanced user.

Embodiments provide access to the network connections, online memberships, and publicly available information of a particular individual associated with a platform according to embodiments. According to embodiments, this information is made available through generation of a platform NaaS network consisting of relevant information gathered from registered users. In addition, embodiments may augment the platform NaaS network with information from non-registered users by leveraging the information provided by registered users. For example, embodiments provide that the platform may use social network connections of registered users to obtain connections with non-registered members. In addition, the connections with non-registered users may be used to locate further connections, relationships, or information about registered and non-registered information. A non-restrictive illustration provides that a platform member is connected to a non-registered user in LinkedIn®, embodiments provide that the platform NaaS network may be augmented by searching the non-registered user's connections, public records, and information available through an Internet search in order to fill out the non-registered user's information within the platform NaaS network.

Embodiments provide for multiple categories of networks within the talent management platform. According to embodiments, one category consists of private networks that are comprised of members associated with one or more private entities and these members' associated networks. In addition, embodiments provide for public networks comprised of members not affiliated with a private entity. According to embodiments, NaaS may be comprised a private network, multiple private networks, the public network, or some combination thereof.

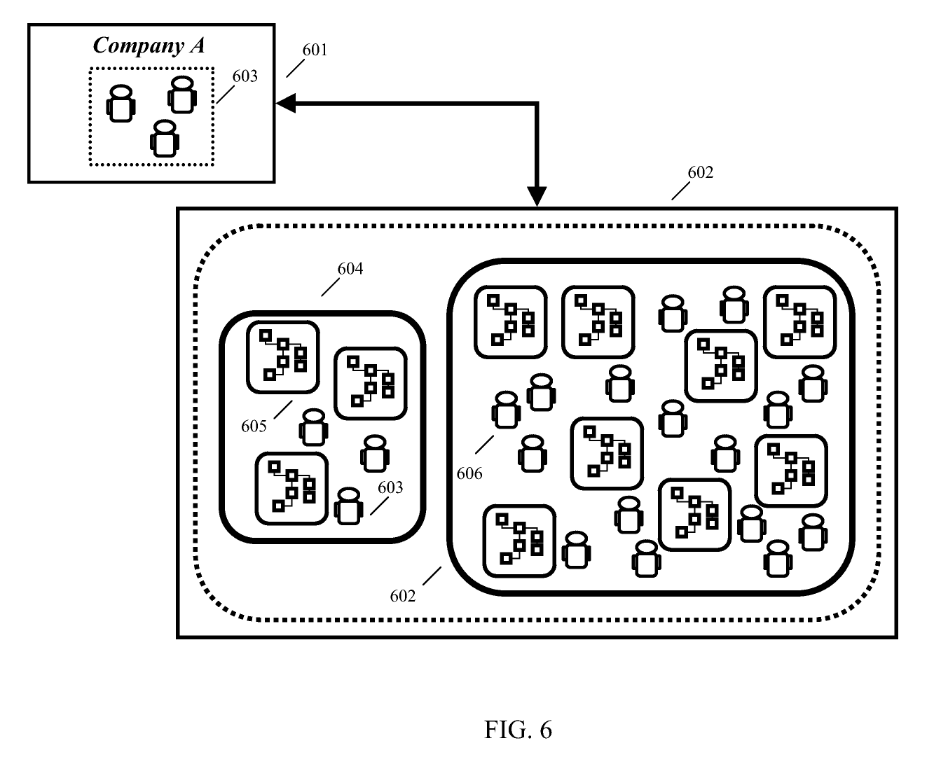

Referring to FIG. 6, therein is provided an example of private and public networks according to an embodiment. Company A 601 enters into an association with the talent management platform 602. The employees 603 of Company A 601 are registered as private members within the platform 602 through the generation of a Company A private network 604 consisting of the Company A employees 603 and social graphs 605 associated with the employees 605, including, but not limited to, social networks and professional networks. Embodiments provide that private networks, such as the Company A private network 604 depicted in FIG. 6, are only accessible to the private entity associated with the network and its members. As such, only Company A 601 may access the Company A private network 604.

Also illustrated in FIG. 6 are public members 606, who are platform 602 members not affiliated with a private entity, such as Company A 601. The public members 606 form a public network 607 within the platform. According to embodiments, private entities may only access their own private networks and may not access the public network 607 unless an arrangement (e.g., a fee, subscription, etc.) is created between the private entity and the talent management platform. In addition, access to a private network is not available to the public platform membership or to other private entities, because access to a specific private network is limited to the specific private entity associated with the network, unless access is otherwise provided for, such as in a sharing or exchange agreement.

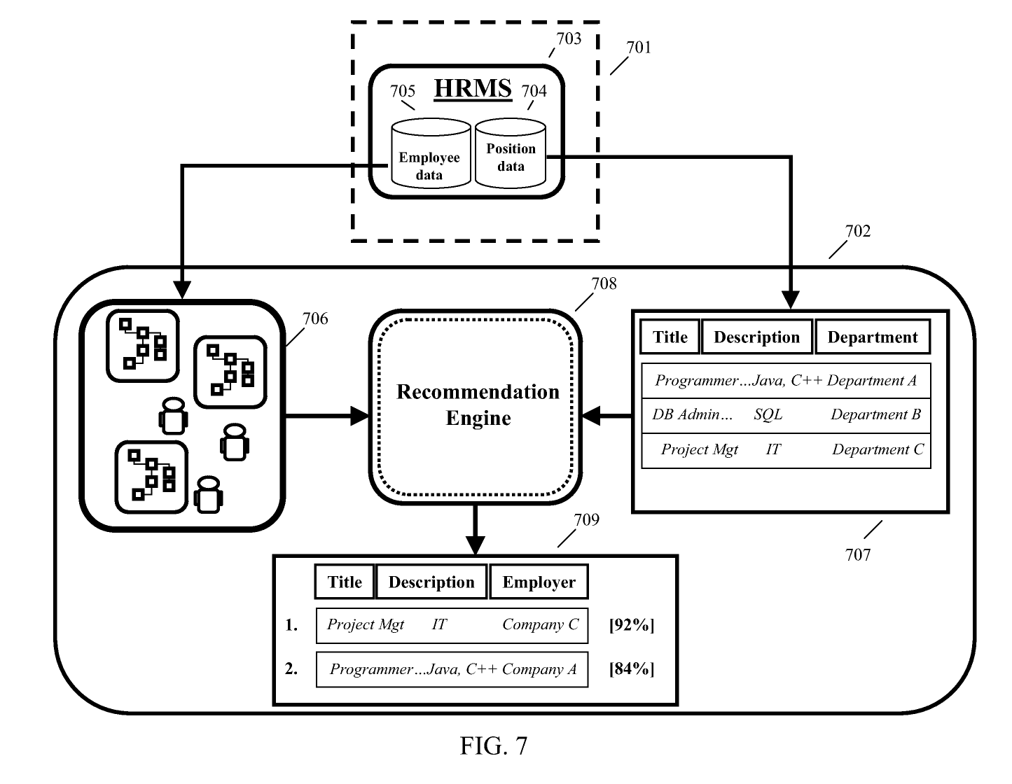

Referring to FIG. 7, therein is depicted an example of recommendation engine operation with a private network according to an embodiment. A private entity 701 has a human resources management system (HRMS) 703 that contains position data 704 and employee data 705. The employee data 705 is accessed by the talent management platform 702 to create a private network 706 and the position data 704 is accessed to create private entity job listings 707. The private network 706 consists of employees of the private entity, who are registered as private members within the platform, and their associated social graphs, such as their LinkedIn® connections. The recommendation engine 708 accesses and analyzes the job listings 707 and the private network 706 and generates candidate recommendations 709 for the job listings 707. In addition, if an arrangement is made between the private entity 701 and the platform 702, the recommendation engine may additionally access and analyze the platform public network (not shown) when generating candidate recommendations 709.

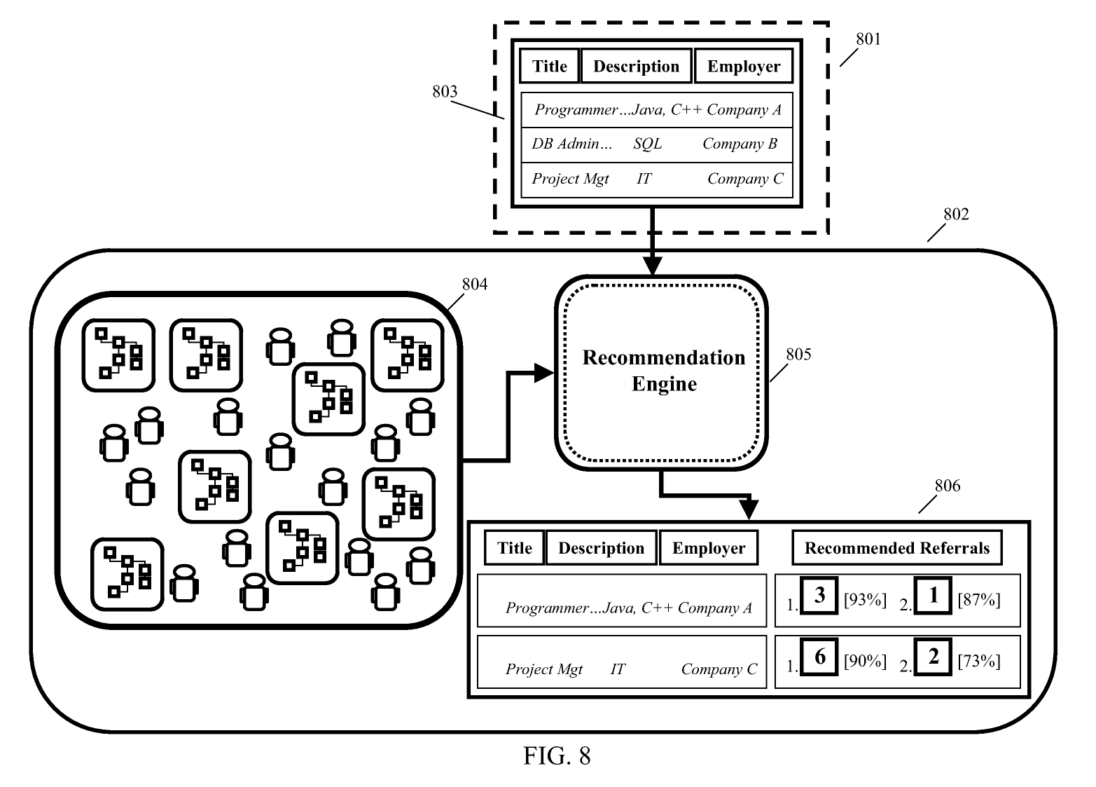

Referring to FIG. 8, therein is depicted an example of recommendation operation with a staffing firm entity according to an embodiment. A staffing firm 801 has a repository of jobs 803 it is attempting to fill for clients. The talent management platform 802 accesses the jobs repository 803, and this information along with the public network 804 are accessed by the recommendation engine 805. The recommendation engine 805 analyzes the jobs repository 803 information in relation to information from the public network 804, and generates candidate recommendations 806 for the jobs listed in the jobs repository 803.

Embodiments are configured to generate platform networks comprised of different levels. In addition, certain embodiments may grant differential access to platform networks. A non-limiting example provides that a platform network may have a first layer comprised of platform members, a second layer of LinkedIn® connections to platform members, a third layer of Facebook® connections to platform members, and a fourth layer comprising professional network connections, such as networks affiliated with certain industries and professions (e.g., electrical engineering, accounting). According to embodiments, the talent management platform may have certain arrangements with entities wherein the entities may only access certain platform network layers, unless another arrangement (e.g., fee, subscription, etc.) is created between an entity and the platform.

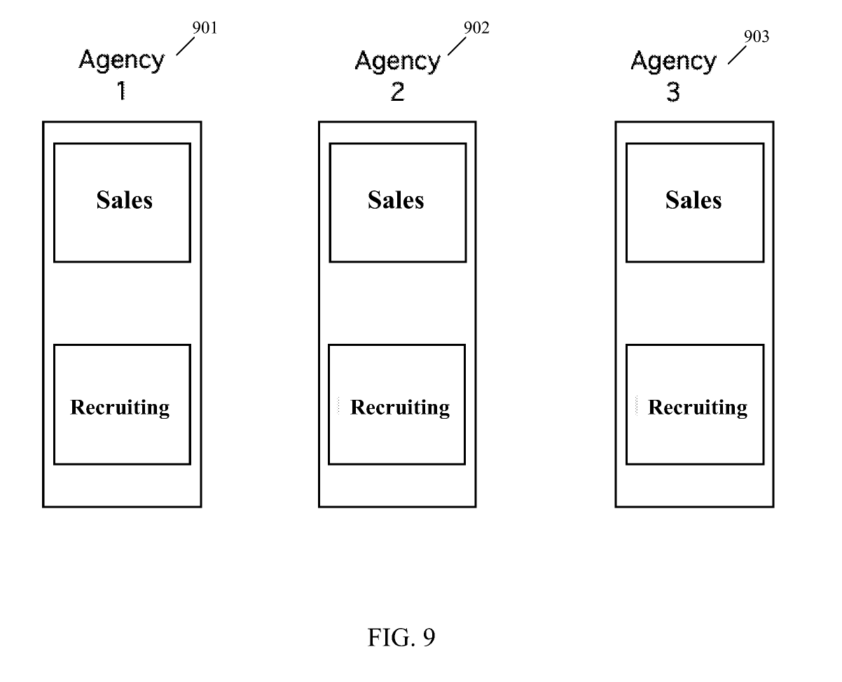

Embodiments provide for a job referral exchange comprising a “marketplace” of jobs, referrals, and job candidates. A recruiting agency consists of two main functions, sales and recruiting. The sales function involves finding qualified candidates for positions at the request of clients. The recruiting function concerns finding positions for candidates using the agency to obtain employment or find another job. As shown in FIG. 9, according to current technology, multiple agencies 901-903 each have their own individual sales and recruiting functions without any real overlapping or sharing of resources, jobs, or candidates. Embodiments provide a job referral exchange that supplies an opportunity for multiple agencies, HR departments, and employers to access open positions and referrals in a marketplace environment.

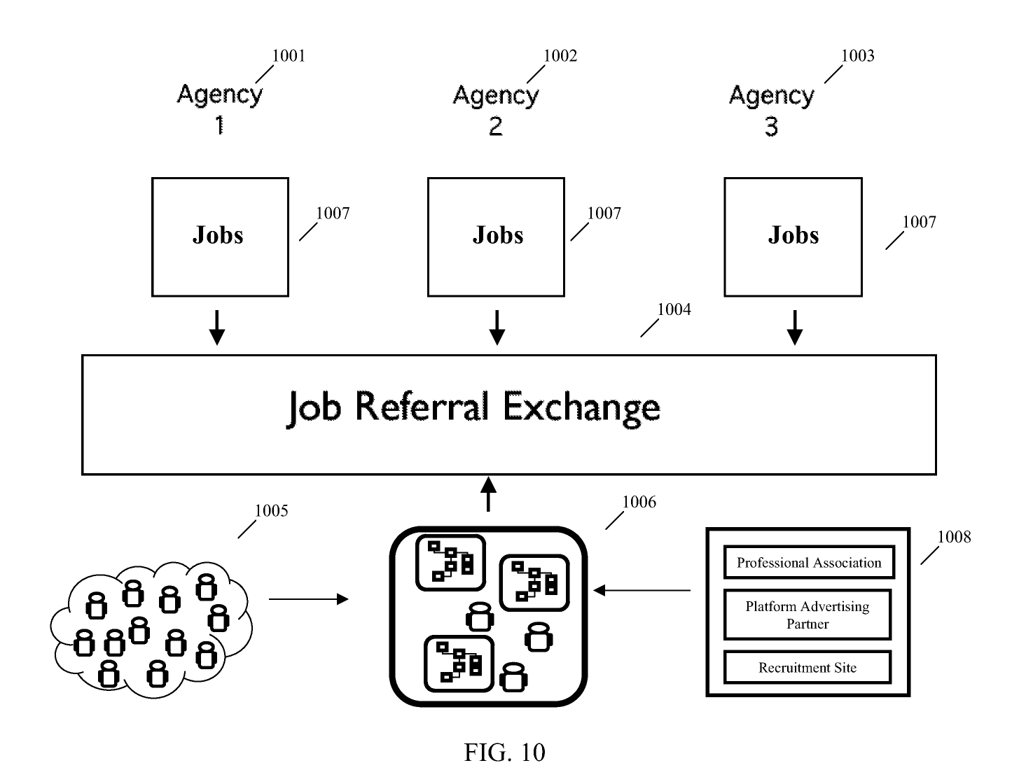

Referring to FIG. 10, therein is depicted an example job referral exchange according to an embodiment. In FIG. 10, the sales (jobs) 1007 from multiple agencies 1001-1003 may be input into the job referral exchange 1004 to provide a pool of available jobs. In addition, the candidates 1005 associated with the agencies 1001-1003 may be registered with the talent management platform 1006 and combined with members already associated with the talent management platform 1006 and their network connections as a pool of candidates available to fill the jobs 1007 provided within the job referral exchange. According to embodiments, the jobs 1007 available through the job referral exchange 1004 may be input into a recommendation engine (not shown) according to embodiments and the resultant referrals input into the job referral exchange 1004 and made available to the agencies 1001-1003. In addition, other recruitment vehicles 1008, such as professional recruitment web sites, professional associations, and advertising partners may provide input of potential candidates to the talent management platform 1006.

Embodiments provide for a talent management platform user interface wherein a member may access multiple aspects of the platform from a unified interface. As a non-limiting example, the member may access the interface and view a list of connections, which may comprise platform network connections or external network connections (e.g., social network connections), and associated information. For each connection, a list of jobs wherein the connection may be a quality referral may be listed along with information related to each listed job. As such, a user may view all of his connections and all available jobs where the connection may be a quality referral from a common interface. According to embodiments, the member may select to view all of the available jobs and the interface would display potential referrals derived from the member's connections. In addition, embodiments provide that the member may be able to use the interface to view all available jobs, for example, ranked by how well they fit the member's profile and qualifications.

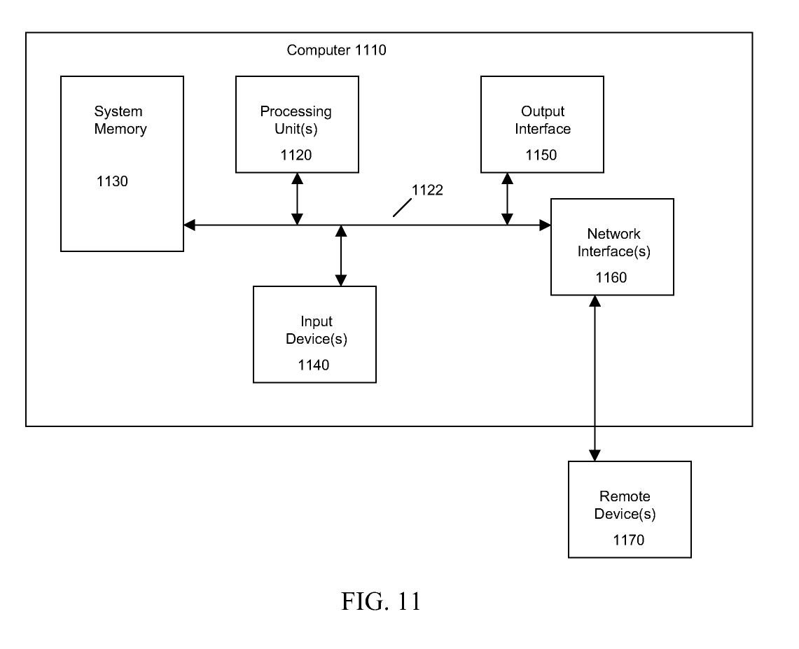

Referring to FIG. 11, it will be readily understood that certain embodiments can be implemented using any of a wide variety of devices or combinations of devices. An example device that may be used in implementing one or more embodiments includes a computing device in the form of a computer 1110.

Components of computer 1110 may include, but are not limited to, a processing unit 1120, a system memory 1130, and a system bus 1122 that couples various system components including the system memory 1130 to the processing unit 1120. The computer 1110 may include or have access to a variety of computer readable media. The system memory 1130 may include computer readable storage media in the form of volatile and/or nonvolatile memory such as read only memory (ROM) and/or random access memory (RAM). By way of example, and not limitation, system memory 1130 may also include an operating system, application programs, other program modules, and program data.

A user can interface with (for example, enter commands and information) the computer 1110 through input devices 1140. A monitor or other type of device can also be connected to the system bus 1122 via an interface, such as an output interface 1150. In addition to a monitor, computers may also include other peripheral output devices. The computer 1110 may operate in a networked or distributed environment using logical connections to one or more other remote computers or databases. The logical connections may include a network, such local area network (LAN) or a wide area network (WAN), but may also include other networks/buses.

It should be noted as well that certain embodiments may be implemented as a system, method or computer program product. Accordingly, aspects may take the form of an entirely hardware embodiment, an entirely software embodiment (including firmware, resident software, micro-code, et cetera) or an embodiment combining software and hardware aspects that may all generally be referred to herein as a “circuit,” “module” or “system.” Furthermore, aspects may take the form of a computer program product embodied in one or more computer readable medium(s) having computer readable program code embodied therewith.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, et cetera, or any suitable combination of the foregoing.

Computer program code for carrying out operations for various aspects may be written in any combination of one or more programming languages, including an object oriented programming language such as Java™, Smalltalk, C++ or the like and conventional procedural programming languages, such as the “C” programming language or similar programming languages. The program code may execute entirely on a single computer (device), partly on a single computer, as a stand-alone software package, partly on single computer and partly on a remote computer or entirely on a remote computer or server. In the latter scenario, the remote computer may be connected to another computer through any type of network, including a local area network (LAN) or a wide area network (WAN), or the connection may be made for example through the Internet using an Internet Service Provider.

Aspects are described herein with reference to flowchart illustrations and/or block diagrams of methods, apparatuses (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Although illustrated example embodiments have been described herein with reference to the accompanying drawings, it is to be understood that embodiments are not limited to those precise example embodiments, and that various other changes and modifications may be affected therein by one skilled in the art without departing from the scope or spirit of the disclosure.

What is claimed is:

1. A system comprising:
one or more processors;
a system memory operatively coupled to the one or more processors; and
one or more aggregation modules communicatively coupled to the system memory, wherein the one or more aggregation modules are adapted to:
register one or more system members, each of the one or more system members belonging to one or more social graphs;
aggregate a social graph network of the one or more social graphs;
access profile information of members of the social graph network;
analyze the social graph network and the profile information for connections between the one or more social graphs; and
provide a access to the one or more social graphs through the social graph network.

2. The system according to claim 1, wherein the one or more social graphs comprise one or more social networks.

3. The system according to claim 1, wherein the one or more social graphs comprise an alumni network and a professional network.

4. The system according to claim 1, wherein the one or more social graphs comprise one or more real time information web sites and one or more content sharing web sites.

5. The system according to claim 1, wherein the profile information is used to locate publicly available information.

6. The system according to claim 5, further comprising one or more talent management modules adapted to:
list one or more positions comprising position information; and
generate referrals for the one or more positions from candidates within the social graph network by applying the profile information to the position information.

7. The system according to claim 5, wherein generating referrals further comprises applying the publicly available information to the position information.

8. The system according to claim 6, wherein the one or more talent management modules are further adapted to:
obtain credentials for the one or more social graphs from the one or more members, the one or more social graphs comprising one or more social networks;
access the one or more social graphs associated with a member using the credentials supplied by the member;
obtain social graph profile information by accessing member profiles of social graph connections connected to the member within the one or more social graphs;
analyze the social graph profiles of each social graph connection to generate inferences based on information contained within the social graph profiles, the inferences relating to employment patterns and professional fitness of the social graph connection;
obtain publicly available information related to each social graph connection by performing an Internet and public information search based on information contained within the social graph profiles;
generate one or more referrals for the one or more positions by applying the inferences and the publicly available information to the position information.

9. A method comprising:
registering one or more system members, each of the one or more system members belonging to one or more social graphs;
aggregating a social graph network of the one or more social graphs;
accessing profile information of members of the social graph network;
analyzing the social graph network and the profile information for connections between the one or more social graphs; and
providing access to the one or more social graphs through the social graph network.

10. The method according to claim 9, wherein the one or more social graphs comprise one or more social networks.

11. The method according to claim 9, wherein the one or more social graphs comprise an alumni network and a professional network.

12. The method according to claim 9, wherein the one or more social graphs comprise one or more real time information web sites and one or more content sharing web sites.

13. The method according to claim 9, wherein the profile information is used to locate publicly available information.

14. The method according to claim 13, further comprising one or more talent management modules adapted to:
list one or more positions comprising position information; and
generate referrals for the one or more positions from candidates within the social graph network by applying the profile information with the position information.

15. The method according to claim 13, wherein generating referrals further comprises applying the publicly available information to the position information.

16. A computer program product comprising:
a computer readable storage medium having computer readable program code embodied therewith, the computer readable program code comprising:
computer readable program code configured to register one or more system members arranged in one or more system networks, each of the one or more members belonging to one or more external networks;
computer readable program code configured to register one or more system members, each of the one or more system members belonging to one or more social graphs;
computer readable program code configured to aggregate a social graph network of the one or more social graphs;
computer readable program code configured to access profile information of members of the social graph network;
computer readable program code configured to analyze the social graph network and the profile information for connections between the one or more social graphs; and
computer readable program code configured to provide access to the one or more social graphs through the social graph network.
